(19) United States
(12) Patent Application Publication
(10) Pub. No.: US 2013/0044056 A1
(43) Pub. Date: Feb. 21, 2013

(54) Computer mouse controller having force-based cursor rate mechanism

(71) Applicants: Boris Kamentser, Fountain Valley, CA (US); Eugenia Kamentser, Fountain Valley, CA (US)

(72) Inventors: Boris Kamentser, Fountain Valley, CA (US); Eugenia Kamentser, Fountain Valley, CA (US)

(73) Assignee: Bokam Engineering, Inc.

(21) Appl. No.: 13/136,933

(22) Filed: Aug. 15, 2011

(51) Int. Cl. G06F 3/033

(52) U.S. Cl. 345/163

(57) ABSTRACT

A computer mouse controller that employs a joystick-style cursor control mechanism. This cursor control mechanism employs a plurality of strain transducers affixed to a substrate to which a vertical mechanical post is attached. The upper free end of the post may be mechanically coupled to a shell shaped as a body of revolution such as a hemispheric-shaped shell. The mechanical coupling between the post and the ball-shaped shell may be a hard unyielding attachment or an intermediate compliant device such as a spring or rubber-like member to permit some limited movement of the ball-shaped shell relative to the post. The strain transducers are preferably arranged and connected in a bridge or half bridge configuration in two orthogonal axes. The application of a horizontally directed force to the free end of the post, imparts strain (tension or compression) to the transducers in the bridge depending upon the direction, thereby altering the impedance of the transducers along respective axes. A commensurate change in the output voltages increases the rate of cursor movement.

### BACKGROUND OF THE INVENTION

1. Field of the Invention

The present invention relates to the field of computer control devices. More specifically, the invention relates to a mouse controller having an on-screen cursor control mechanism which provides both direction and rate of cursor movement by direction and magnitude, respectively, of force applied to a transducer on the controller. In the preferred embodiment, the mouse controller uses a ball-style transducer with no actual movement. However, other embodiments with differently shaped transducers and limited movement for physically sensing some compliance in the transducer, may be provided.

2. Background Art

A mouse is utilized in processor-based systems to enable the user to supply input commands. The user can move the mouse in his or her hand to adjust the position of an on-screen cursor. Icons displayed on screen may then be selected by operating mouse buttons.

The cursor moves on the screen at a rate which is about the same as the speed at which the user moves the mouse. There is a correlation between hand and cursor movements.

In some cases, especially when big movements are needed, the ability to use software is limited by the cursor rate. In a number of situations, slow cursor control movements may be problematic. The user may be able to input data at a faster rate if the mouse cursor can be moved more quickly.

In a number of different software routines, there are settings which control the rate of cursor movement with respect to the rate of mouse movement in the user's hand. These settings enable adjustment of the rate of movement of the cursor relative to the speed of mouse movement. However, there is a need for more adjustability in the way that cursors respond to pointing device movements

A search of the relevant prior art has revealed the following issued U.S. Pat. Nos. and a published patent application:
U.S. Patent Application Publication No. 20020135563 to Canakapalli
U.S. Pat. No. 5,075,673 to Yanker
U.S. Pat. No. 5,313,229 to Gilligan et al
U.S. Pat. No. 6,937,227 to Qamhiyah et al

Of the listed patents, the '673 and '229 patents disclose cursor rate control that is programmed to depend on the screen position of the cursor. The published application has a special extra button for thumb control of cursor speed. The most relevant disclosure is the '227 patent which discloses a pointing device having force based soft-material-pressed areas. However, this device does not have the standard mouse configuration and it does not have a ball-style cursor position control. There is no known prior art disclosure of a standard shaped mouse having a ball-style control mechanism which doesn't rotate and responds to ball applied force to control cursor position, direction and movement rate. There does not appear to be any known prior art showing a conventional mouse configuration, but where a single cursor control device provides cursor position, direction and rate control.

### SUMMARY OF THE INVENTION

The present invention comprises a computer mouse controller that employs a joystick-style cursor control mechanism. This cursor control mechanism employs a plurality of strain transducers affixed to a substrate to which a vertical mechanical post is attached. The upper free end of the post may be mechanically coupled to a body of revolution such as a hemispheric-shaped shell. The mechanical coupling between the post and the ball-shaped shell may be a hard unyielding attachment or an intermediate compliant device such as a spring or rubber-like member to permit some limited movement of the ball-shaped shell relative to the post.

The strain transducers are preferably arranged and connected in a bridge or half bridge configuration in two orthogonal axes such as disclosed in issued U.S. Pat. Nos. 5,835,977 and 5,872,320. The application of a horizontally directed force to the free end of the post, imparts strain (tension or compression) to the transducers in the bridge depending upon the direction, thereby altering the impedance of the transducers along respective axes. Input voltages applied to the bridge are also acted upon, depending upon the change in impedances to produce output voltages in respective axes which produce movement of a screen cursor in a corresponding direction. Increasing the magnitude of the force applied to the post increases the strain of the transducers and the extent of impedance change in the bridges. A commensurate change in the output voltages increases the rate of cursor movement. The preferred embodiment employs an overlying ball and right and left “click” buttons as in a conventional mouse.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a preferred embodiment of the invention;

FIG. 2 is an elevational view of the embodiment of FIG. 1;

FIG. 3 is a side view;

FIG. 4 is an end view;

FIG. 5 is an exploded view;

FIG. 6 is a cross-sectional view; and

FIGS. 7 and 8 are cross-sectional views similar to FIG. 6, but showing respective alternative embodiments.

### DETAILED DESCRIPTION OF PREFERRED EMBODIMENTS

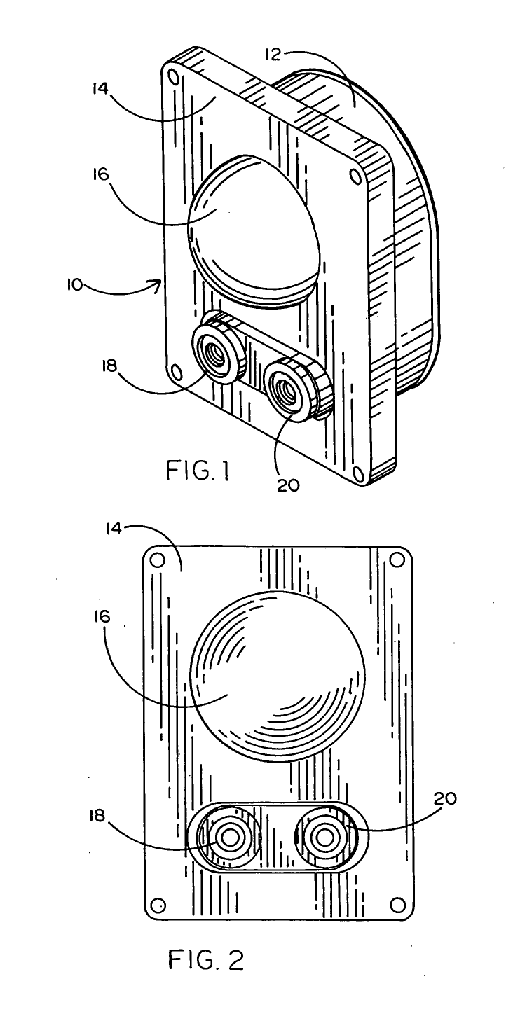

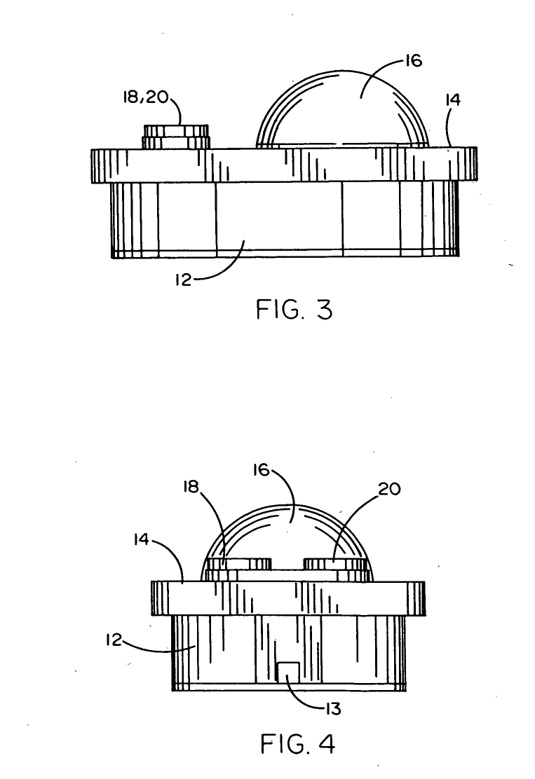

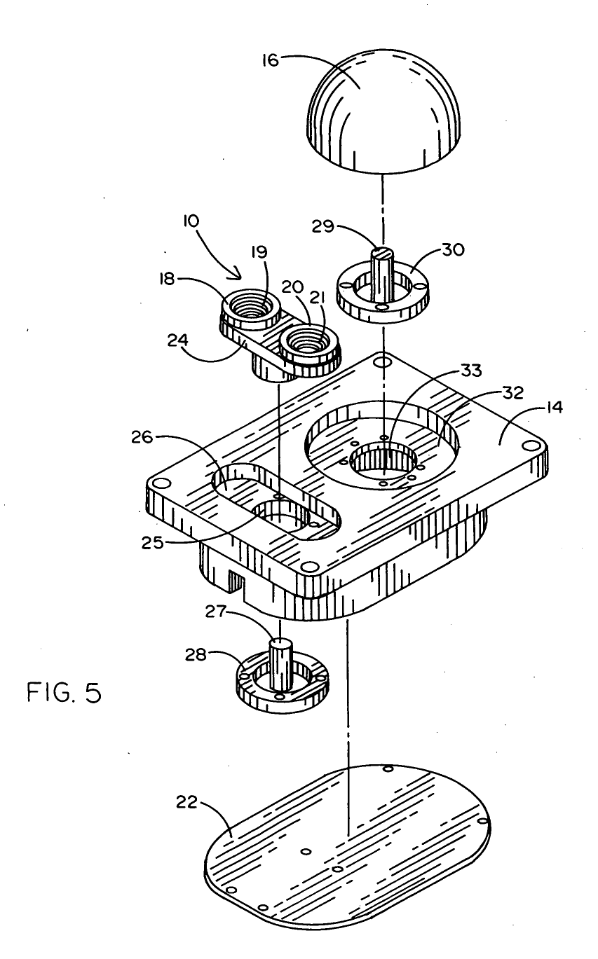

Referring to the accompanying drawings, FIGS. 1-5 in particular, it will be seen that a first embodiment mouse controller 10 has a housing 12 having a planar top surface 14 from which a hemispherical shell 16 and a pair of click switches 18 and 20 extend. A bottom plate 22 encloses the housing to protect the interior components.

Click switches 18 and 20 are both mounted on a common structural member 24 which is, in turn, mounted within a recess 26 in the surface 14. A post 27 extends upward through an aperture 25. The post 27 has a free end which sits adjacent switches 18 and 20 and a secured end which is mounted to a strain transducer assembly 28. Depressing either of switches 18 and 20 by pressing on respective corresponding membranes 19 and 21, will place a force on post 27 in a corresponding direction, thereby causing a respective response in a bridge circuit immediately adjacent the secured end of post 27. Switch 18 is thus configured as a right click switch and switch 20 as a left click switch, each performing a conventional “click” function that would be found on ordinary prior art mouse controllers. A cable (not shown) connects the mouse through port 13 seen best in FIG. 4, to a computer system.

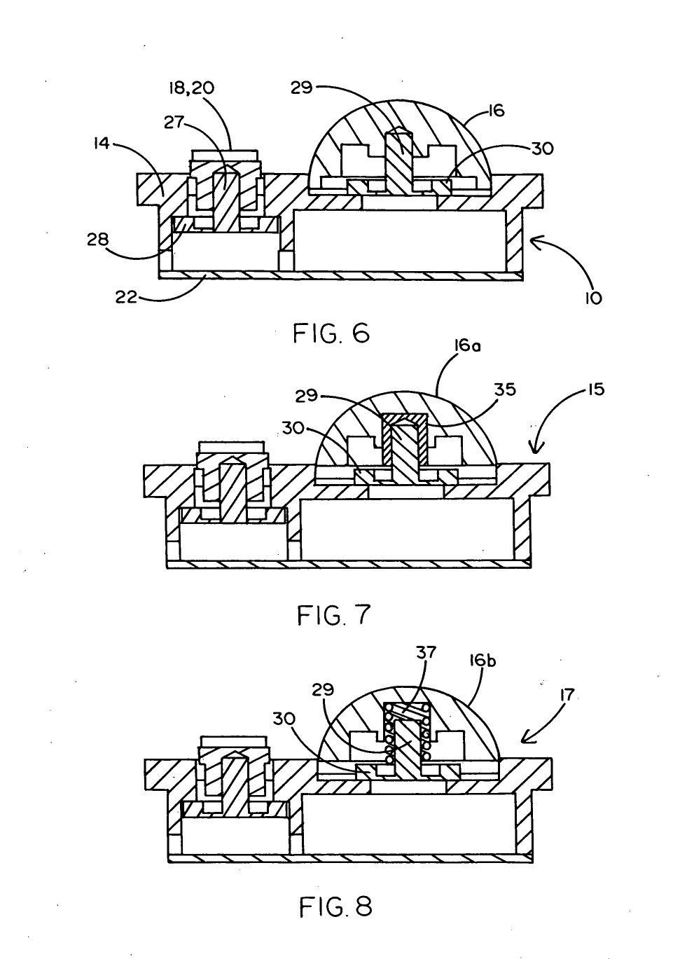

The cursor control function is provided by shell 16, post 29 and transducer assembly 30 in a similar fashion. Assembly 30 resides in a recess 32 of surface 14. An aperture 33 provides a passage for wires (not shown), extending from a pair of strain transducer bridges (2 axes) in the assembly 30. Post 29 has a free end connected to the interior of shell 16 as shown in FIG. 6 and a secured end adjacent the transducer bridges of assembly 30.

The construction and operation of transducer assemblies 28 and 30 are fully disclosed in issued U.S. Pat. Nos. 5,835,977 and 5,872,320 to the inventors herein and therefore need not be repeated here. The entire contents of U.S. Pat. Nos. 5,835,977 and 5,872,320 are hereby incorporated herein by reference and form a part hereof as if fully set forth herein. Suffice it to state that upon application of a force, such as by friction with a finger or hand palm, to the exterior surface of shell 16, a corresponding force is applied directly to post 29. Assembly 30 generates a corresponding output voltage in each of two axis circuits. The mix and magnitude of these output voltages determine the motion, direction and rate of movement of a cursor on a computer screen. Motion of the cursor will result from any non-zero output voltage from the circuits of strain transducers. Direction will be dictated by the vector of the two axis output voltages and cursor motion rate by the magnitude of the respective voltages. Thus two equal axis output voltages of x millivolts will produce a cursor movement along a diagonal on the computer screen. However, an equal output of 10x millivolts in each axis resulting from a larger applied force to shell 16, will produce movement along the same cursor direction, but at a commensurately greater rate of movement along the computer screen. Of course, applying force in a different direction will change the respective output voltages and thereby change the direction of cursor movement.

It will be observed in FIG. 6 that the shell 16 is connected directly to post 29. As a result there will be no perceptible movement of the shell 16 upon application of force to the shell. In some instances it may be more appropriate to provide a shell, such as a shell 16a of FIG. 7, or shell 16b of FIG. 8, wherein there is some compliance or perceptible movement or rotation of the shell upon the application of force. Shell 16a of embodiment 15 of FIG. 7 is configured to have some limited freedom of angular movement such as 5° to 10°. Moreover, a compliant material such as rubber bushing 35 is placed over the post 29 to provide a smoothly responsive sense of movement to shell 16a. Similarly, as shown in FIG. 8, the space provided between the post 29 and the shell 16b can be used to receive a helical spring 37 which is the compliant member of the embodiment 17 of FIG. 8. Here again the shell 16b is configured for a limited angular motion of 5° to 10°. Of course it will be apparent that other post/shell interfaces, whether compliant or not, are readily available.

It will now be apparent that the present invention provides a mouse controller for use with a computer to control movement of a screen cursor. A force applied to a post effects an output voltage in two axes of strain transducer bridges to control cursor motion in both direction and rate. A fixed or slightly compliant ball may be employed, as well as click switches.

We claim:

1. A mouse controller for operation with a computer to control a cursor on a screen display of the computer; the mouse controller comprising:
a housing forming an interior chamber;
a substrate mounted in said interior chamber;
a post having an axis and being affixed at a first end to said substrate and having free second end extending through said housing for exterior access;
a plurality of strain transducers mounted on said substrate adjacent said post first end and arranged mechanically and electrically to form a pair of orthogonal axis sensors to respond to substrate torsion;
said strain transducers connected as electrical bridges to generate output voltages dependent upon the direction and magnitude of a force applied to said free end of said post perpendicular to said axis.

2. The mouse controller recited in claim 1 further comprising a shell configured as a body of revolution positioned on the exterior of said housing and being symmetrically centered over said post free end;
said shell being mechanically coupled to said post free end whereby a force applied to said shell is transferred to said post.

3. The mouse controller recited in claim 2 wherein said shell is mechanically coupled to said post free end by direct connection of said post free end at the interior surface center of said shell.

4. The mouse controller recited in claim 2 wherein said shell is mechanically coupled to said post free end by a compliant member attached to said post free end and to the interior surface of said shell.

5. The mouse controller recited in claim 4 wherein said compliant member comprises a spring.

6. The mouse controller recited in claim 4 wherein said compliant member comprises a rubber-like device.

7. The mouse controller recited in claim 1 further comprising at least one click switch positioned on said housing.

8. The mouse controller recited in claim 1 further comprising a right click switch and a left click switch positioned on said housing.

9. A computer mouse having a cursor control and at least one click switch for positioning a cursor on a computer screen and clicking on icons on the screen; the computer mouse comprising:
a substrate having a post extending perpendicularly from a surface of the substrate, the post having a free end extending to a location that is accessible by a user for applying a force to said free end for moving said cursor on said screen;
an array of strain transducers arranged on said substrate adjacent said post and forming a pair of electronic bridges corresponding to two orthogonal axes for related motion of said cursor in response to said force applied to said free end of said post; and
a cable connecting said computer mouse to a computer for transferring electrical signals to said screen for moving said cursor in response to force applied to said post free end;
forces applied to said free end controlling said cursor in position, motion and rate of movement on said screen.

10. The computer mouse recited in claim 9 further comprising a hemispherically-shaped shell symmetrically centered over said post free end and being mechanically coupled to said post for transferring force to said free end.

11. The computer mouse recited in claim 10 wherein said shell is mechanically coupled to said post free end by direct connection of said post free end at the interior surface center of said shell.

12. The computer mouse recited in claim 10 wherein said shell is mechanically coupled to said post free end by a compliant member attached to said post free end and to the interior surface of said shell.

13. The computer mouse recited in claim 12 wherein said compliant member comprises a spring.

14. The computer mouse recited in claim 12 wherein said compliant member comprises a rubber-like device.
